(19) United States
(12) Patent Application Publication
(10) Pub. No.: US 2013/0165187 A1
(43) Pub. Date: Jun. 27, 2013

(54) APPARATUS AND METHOD FOR CONTROLLING DATA TRANSMISSION BASED ON POWER CONSUMPTION OF NODES IN A COMMUNICATION NETWORK

(71) Applicant: FUJITSU LIMTED, Kawasaki-shi (JP)

(72) Inventors: Yuzo KUSAKABE, Fukuoka (JP); Shinya Yamamura, Fukuoka (JP); Hiroshi Yamada, Fukuoka (JP); Shinichi Matsumoto, Kanzaki (JP); Masayoshi Kamada, Dazaifu (JP)

(73) Assignee: FUJITSU LIMITED, Kawasaki-shi (JP)

(21) Appl. No.: 13/724,824

(22) Filed: Dec. 21, 2012

(30) Foreign Application Priority Data
Dec. 27, 2011 (JP) 2011-286825

(51) Int. Cl. H04W 52/02

(52) U.S. Cl. CPC H04W 52/0209
USPC 455/574

(57) ABSTRACT

Each of nodes along multiple routes in a communication network is provided with route information including information on the multiple routes each communicably coupling a transmission source and a transmission destination. A first route has power consumption least among the multiple routes, where the power consumption of a route is a total sum of power consumption of nodes along the route. Upon receiving realtime data, the each node transmits the realtime data using the first route when the first route has available bandwidth capacity enough for transmitting the realtime data, and sets a second route bypassing the first route when the first route does not have available bandwidth capacity enough for transmitting the realtime data. Upon receiving non-realtime data, the each node performs a predetermined processing without setting the second route, when the first route does not have available bandwidth capacity enough for transmitting the non-realtime data.

### CROSS-REFERENCE TO RELATED APPLICATION

This application is based upon and claims the benefit of priority of the prior Japanese Patent Application No. 2011-286825, filed on Dec. 27, 2011, the entire contents of which are incorporated herein by reference.

### FIELD

The embodiments discussed herein are related to a system and method for controlling data transmission based on power consumption of nodes in a communication network.

### BACKGROUND

In recent years, due to grow in capacity of traffic on communication networks, the power consumption of network devices and the electricity price are prone to increase, thereby increasing the operation cost of the networks.

In order to suppress the power consumption, power saving network control techniques that control and manage the entire network to reduce the power consumption are proposed (for example, refer to Japanese Laid-open Patent Publication No. 2011-77954). In such a power saving network control technique, a management server obtains information on the device configuration in the entire network and the presence or absence of a power saving function, and configures a route capable of transferring the traffic with power consumption as low as possible so that a transfer device carries out transfer of a communication packet based on the configured route, thereby reducing the power consumption on the entire network.

The following is disclosed, for example, in Japanese Laid-open Patent Publication No. 2000-78188. In terms of the priority depending on the level of realtime properties, a low priority communication packet is temporarily saved to a memory device in a router device, and when a delivery desired time draws near or when congestion is fixed, priority route control is carried out. Further, detour control is further carried out using a relay point option header of IPv6 regardless of the priority route control.

It is also proposed to prioritize communication packets, to provide a communication node with a passing buffer for controlling data transmission depending on the priority, and further to control routing of a detour based on the priority (for example, refer to Japanese Laid-open Patent Publication No. 2000-228677).

Further, it is proposed that a traffic shaping and transfer unit of an ATM switching device is provide with a secondary memory device that memorizes a cell for a long period of time together with a normal input/output buffer, data that does not request realtime properties is memorized, and a packet is output so as not to exceed a predetermined transfer delay tolerance value (for example, refer to Japanese Laid-open Patent Publication No. 6-46081).

### SUMMARY

According to an aspect of the invention, data transmission is controlled based on power consumption of nodes in a communication network. Each of the nodes is provided with communication route information that stores information on a plurality of transmission routes communicably coupling a transmission source and a transmission destination via the communication network. The each node receives transmission data, and transmits the transmission data using a first transmission route having power consumption that is least among the plurality of transmission routes when the transmission data is realtime data and the first transmission route has available bandwidth capacity enough for transmitting the realtime data, where the power consumption of a transmission route is defined as a total sum of power consumption of nodes along the transmission route and the realtime data is data that is required to be transmitted on a realtime basis. The each node sets a second transmission route bypassing the first transmission route when the transmission data is the realtime data and the first transmission route does not have available bandwidth capacity enough for transmitting the realtime data. The each node performs a predetermined process without setting the second transmission route when the transmission data is non-realtime data and the first transmission route does not have available bandwidth capacity enough for transmitting non-realtime data, where the non-realtime data is data that is not required to be transmitted on a realtime basis.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic diagram illustrating an example of traffic transfer at an off-peak time;

FIG. 2 is a schematic diagram illustrating an example of traffic transfer at a peak time;

FIG. 3 is a diagram illustrating an example of a system configuration, according to a first embodiment;

FIG. 4 is a diagram illustrating an example of a system configuration, according to a second embodiment;

FIG. 5 is a diagram illustrating a configuration example of a terminal device, according to an embodiment;

FIG. 6 is a diagram illustrating an example of a packet type assignment policy, according to an embodiment;

FIG. 7 is a diagram illustrating an example of a packet delay tolerance time assignment policy, according to an embodiment;

FIG. 8 is a diagram illustrating an example of a packet delay tolerance time assignment policy, according to an embodiment;

FIG. 9 is a diagram illustrating an example of a packet type assignment policy and a packet delay tolerance time assignment policy, according to an embodiment;

FIG. 10 is a diagram illustrating a configuration example of a gateway device, according to an embodiment;

FIG. 11 is a diagram illustrating a configuration example of a transfer device, according to an embodiment;

FIG. 12 is a diagram illustrating an example of a non-realtime packet transmission policy, according to an embodiment;

FIG. 13 is a diagram illustrating an example of a non-realtime accumulation policy, according to an embodiment;

FIG. 14 is a diagram illustrating an example of information stored in a packet storage, according to an embodiment;

FIG. 15A is a diagram illustrating an example of a realtime communication route table, according to an embodiment;

FIG. 15B is a diagram illustrating an example of a non-realtime communication route table, according to an embodiment;

FIG. 16 is a diagram illustrating an example of a data format of an internet protocol version 6 (IPv6) packet as a communication packet to be transferred;

FIG. 17A is a diagram illustrating an example of an operational flowchart for transmitting a communication packet for realtime communication, according to an embodiment;

FIG. 17B is a diagram illustrating an example of an operational flowchart for transmitting a communication packet for non-realtime communication, according to an embodiment;

FIG. 17C is a diagram illustrating an example of an operational flowchart for transmitting a communication packet from a packet storage, according to an embodiment;

FIG. 18 is a diagram illustrating a configuration example of a management server, according to an embodiment;

FIG. 19A is a diagram illustrating an example of an operational flowchart performed by a route control program of a management server, according to an embodiment;

FIG. 19B is a diagram illustrating an example of an operational flowchart performed by a route control program of a management server, according to an embodiment;

FIG. 20 is a diagram illustrating an example of an operational sequence for processing a communication packet in a transfer source terminal, according to an embodiment;

FIG. 21 is a diagram illustrating an example of an operational sequence for processing a communication packet in a gateway device, according to an embodiment;

FIG. 22 is a diagram illustrating an example of an operational sequence for processing a communication packet in a transfer device, according to an embodiment;

FIG. 23 is a diagram illustrating an example of an operational sequence for processing a communication packet in a transfer device, according to an embodiment;

FIG. 24 is a schematic diagram illustrating an example of traffic transfer at an off-peak time, according to an embodiment; and

FIG. 25 is a schematic diagram illustrating an example of traffic transfer at a peak time, according to an embodiment.

### DESCRIPTION OF EMBODIMENTS

In the above mentioned power saving network control technique, a traffic route is configured so that the lowest power consumption is achieved. However, since setting of a power saving route is determined by the amount of flow of network traffic that is predetermined, even when there is temporal variation in the traffic flow rates, it is difficult to level them along the time axis, and it is necessary to increase routes to be set, in accordance with the peak of traffic. Therefore, there is a limitation in the power saving effect brought by route setting mentioned above.

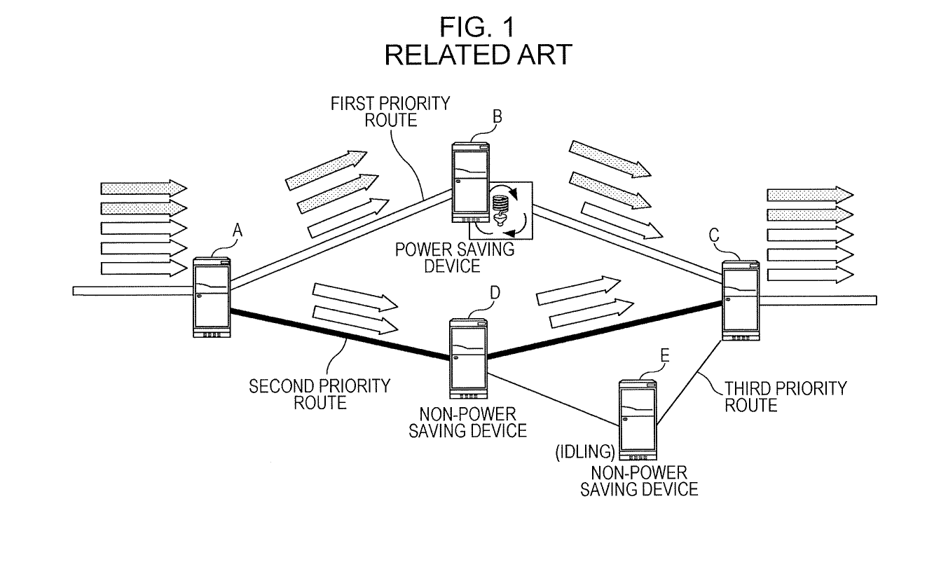

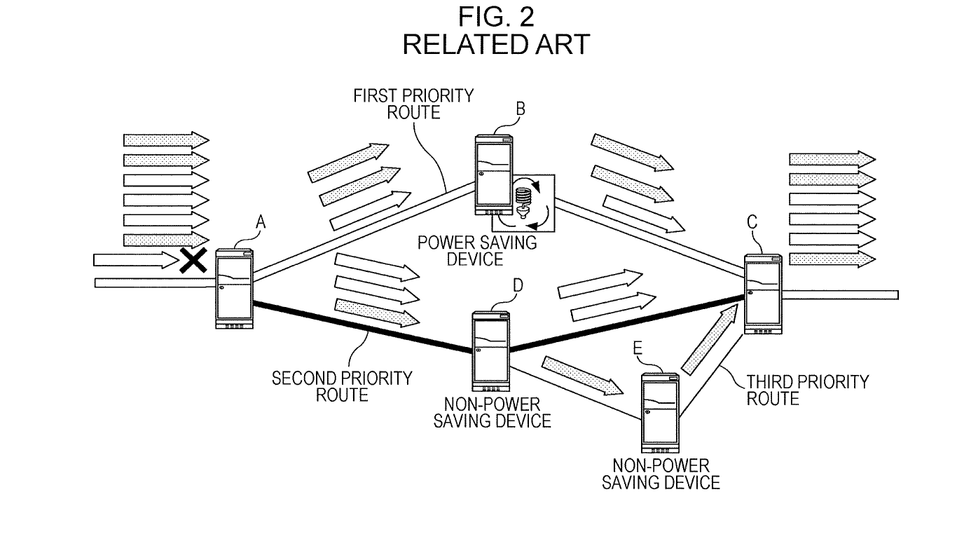

FIG. 1 is a schematic diagram illustrating an example of traffic transfer at an off-peak time, and FIG. 2 is a schematic diagram illustrating an example of traffic transfer at a peak time. FIGS. 1 and 2 illustrate examples of traffic transfer at the off-peak time and the peak time according to a power saving network control technique in the related arts. At the off-peak time illustrated in FIG. 1, since the power saving network control does not make a decision whether the traffic is realtime communication with high realtime properties or non-realtime communication with low realtime properties, the routes are set as, for example, a first priority route (a route passing through transfer devices A, B, and C) and a second priority route (a route passing through transfer devices A, D, and C) so as to allow transfer of all of the non-realtime communication depicted by white arrows and the realtime communication depicted by arrows of the halftone dot mesh pattern. In the case, not only transfer devices on the first priority route but also transfer devices on the second priority route enter a working state, that is, a non-idling state, thereby causing a problem of increasing the power consumption on the entire network.

Similarly, also at the peak time illustrated in FIG. 2, a third priority route (a route passing through transfer devices A, D, E, and C), for example, is set in addition to the first priority route and the second priority route, so as to allow transfer of all communication. Therefore, all transfer devices enter a running state at the peak time, causing a problem of failing to take advantage of the power saving function of the transfer devices on the network.

A description will be given of embodiments with reference to the drawings.

<System Configuration>

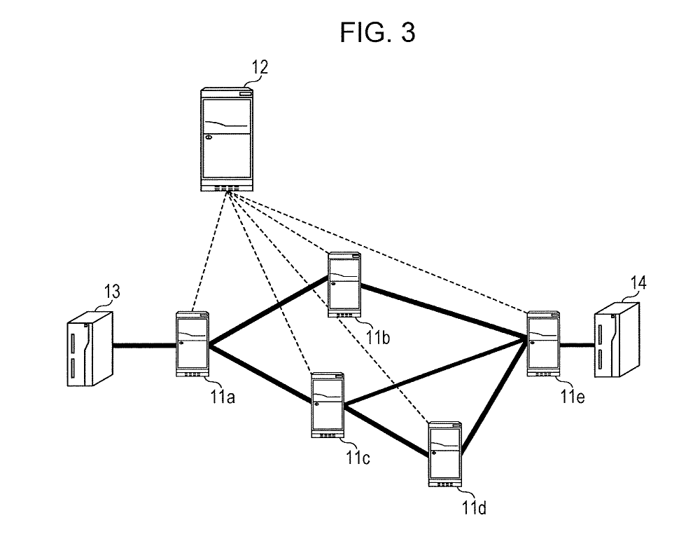

FIG. 3 is a diagram illustrating an example of a system configuration, according to a first embodiment, in which a power saving network control method is used. In the first embodiment, for example, indexes, such as a type of a packet and a packet delay tolerance time, are added to a communication packet by a transfer source terminal. In FIG. 3, transfer devices 11a, 11b, 11c, 11d, and 11e constitute a network. A management server 12 carries out determination and setting of a transmission route to be set in the network. The transmission rout is determined using a route setting request informed from each of the transfer devices 11a, 11b, 11c, 11d, 11e, and power saving indexes kept in the management server 12.

Here, communication between a transfer source terminal 13 and a transfer destination terminal 14 includes realtime communication having high realtime properties and non-realtime communication having low realtime properties. The realtime communication includes VoIP (Voice over Internet Protocol) and streaming. The non-realtime communication is communication in which a next request is sent without waiting for a response from the other party in order to promote efficiency of communication between distributed applications, and includes messaging service. The non-realtime communication tolerates a relatively large delay owing to its properties, and includes sensor network communication and machine to machine (M2M) communication. The non-realtime communication also includes electronic mails and RSS (RDF site summary, rich site summary, or really simple syndication) distribution.

A description will be given of a case in which the transfer source terminal 13 carries out non-realtime communication to the transfer destination terminal 14. The transfer source terminal 13 carries out transmitting and receiving of a communication packet in the non-realtime communication along a route informed from the management server 12. In the transmitting and receiving of a communication packet in the non-realtime communication, a communication packet is accumulated in each of the transfer devices 11a, 11b, 11c, 11d, and 11e, respectively, on the basis of indexes, such as a packet type and a packet delay tolerance time, which are given to the communication packet by the transfer source terminal 13, and it is determined whether to transfer the communication packet or to continue accumulation.

Two kinds of lines, lines for realtime communication and lines for non-realtime communication, are provided for transferring a communication packet between the transfer devices so that the lines for realtime communication is used for realtime communication requiring high realtime properties and the lines for non-realtime communication are used for non-realtime communication having low realtime properties. These lines may be configured as physical lines or logical lines in the network.

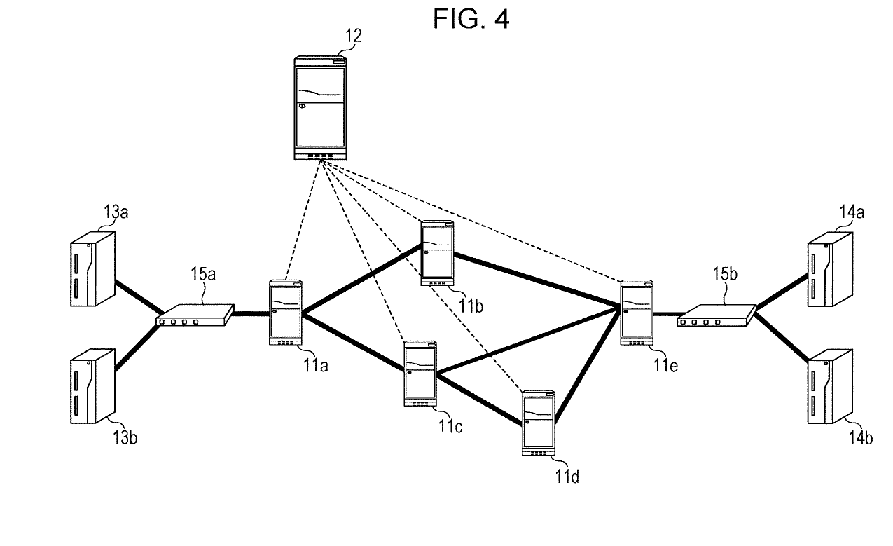

FIG. 4 is a diagram illustrating an example of a system configuration, according to a second embodiment, in which a power saving network control method is used. In the second embodiment, indexes are added to a communication packet by a gateway instead of the transfer source terminal. In FIG. 4, a reference character identical to FIG. 3 denotes an identical part. In FIG. 4, the transfer source terminals 13a and 13b are connected to the transfer device 11a on the network via a gateway 15a, and transfer destination terminals 14a and 14b are connected to the transfer device 11e via a gateway 15b.

In this case, it is not the transfer source terminal 13a but the gateway 15a that gives indexes to a communication packet. The indexes may also be given to a communication packet by a proxy server or the like other than the gateway.

<Transfer Source Terminal>

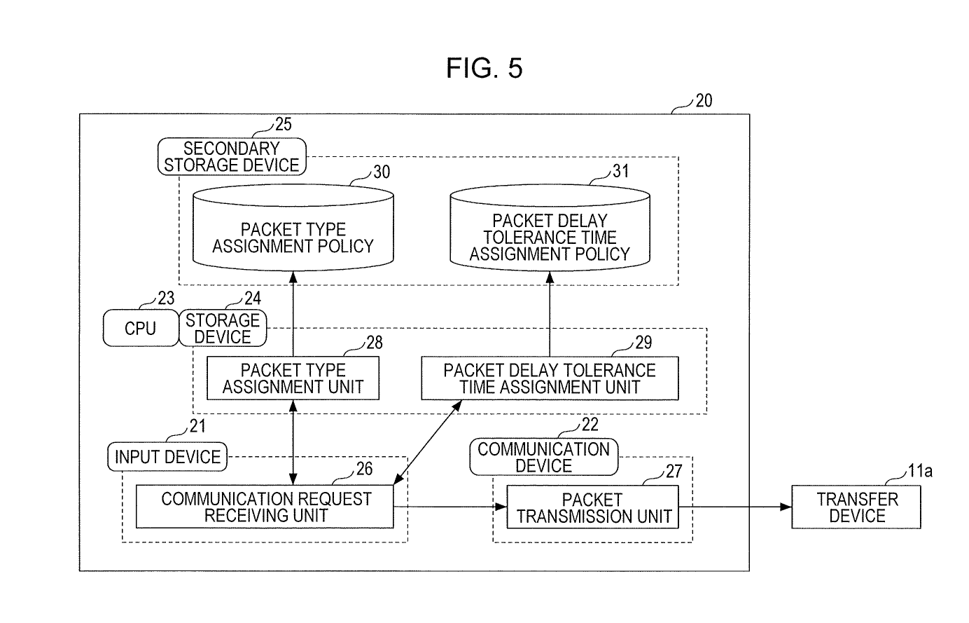

FIG. 5 is a diagram illustrating a configuration example of a terminal device, according to an embodiment. A terminal device 20 depicted in FIG. 5 corresponds to the transfer source terminal 13. The terminal device 20 includes, as a hardware configuration, an input device 21, a communication device 22, a central processing unit (CPU) 23, a memory device 24, and a secondary memory device 25.

The input device 21 functions as a communication request receiving unit 26, and an event, such as data transmission request, is input to the input device 21 by a user. The communication device 22 functions as a packet transmission unit 27, and transmits a data packet supplied from the communication request receiving unit 26 to the transfer devices on the network.

The CPU 23 functions as a packet type assignment unit 28 and a packet delay tolerance time assignment unit 29 by executing a program stored in the memory device 24. The secondary memory device 25 stores a packet type assignment policy 30 and a packet delay tolerance time assignment policy 31.

The communication request receiving unit 26 receives a transmission request from a user and requests the packet type assignment unit 28 and the packet delay tolerance time assignment unit 29 to add a packet type and a packet delay tolerance time to a communication packet to be transmitted. After the packet type and the packet delay tolerance time are added to the communication packet, the communication request receiving unit 26 sends the communication packet to the packet transmission unit 27.

The packet type assignment unit 28 adds a packet type to the communication packet according to the packet type assignment policy 30 and sends the communication packet provided with the packet type to the communication request receiving unit 26.

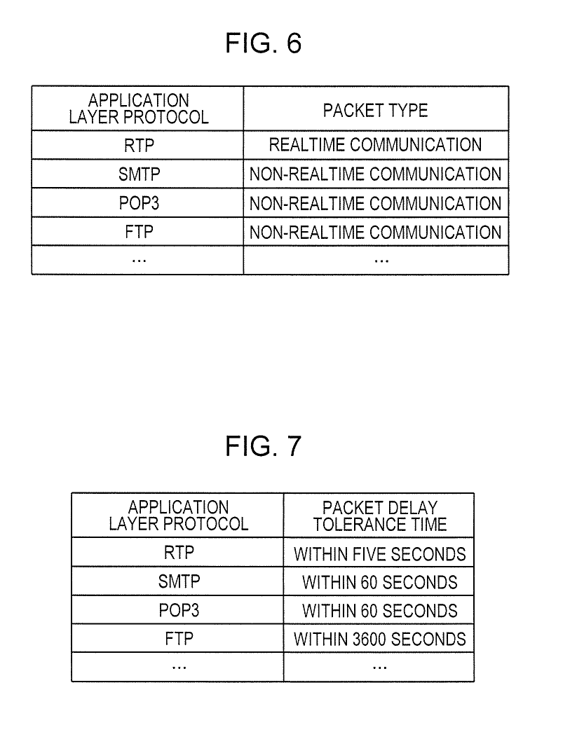

FIG. 6 is a diagram illustrating an example of a packet type assignment policy, according to an embodiment. According to the packet type assignment policy 30 depicted in FIG. 6, the packet type is determined based on an application layer protocol.

In FIG. 6, the packet type of RTP (realtime transport protocol), which is a streaming protocol, is determined to correspond to realtime communication. The packet types of SMTP (simple mail transfer protocol) and POP3 (post office protocol 3), which are electronic mail protocols, are determined to correspond to non-realtime communication. Further, the packet type of FTP (file transfer protocol), which is a file transfer protocol, is determined to correspond to non-realtime communication. The contents of the packet type assignment policy 30 may be modified in accordance with the operation of a network to be used.

The packet delay tolerance time assignment unit 29 adds a packet delay tolerance time to the communication packet according to the packet delay tolerance time assignment policy 31, and sends the communication packet provided with the packet delay tolerance time to the communication request receiving unit 26.

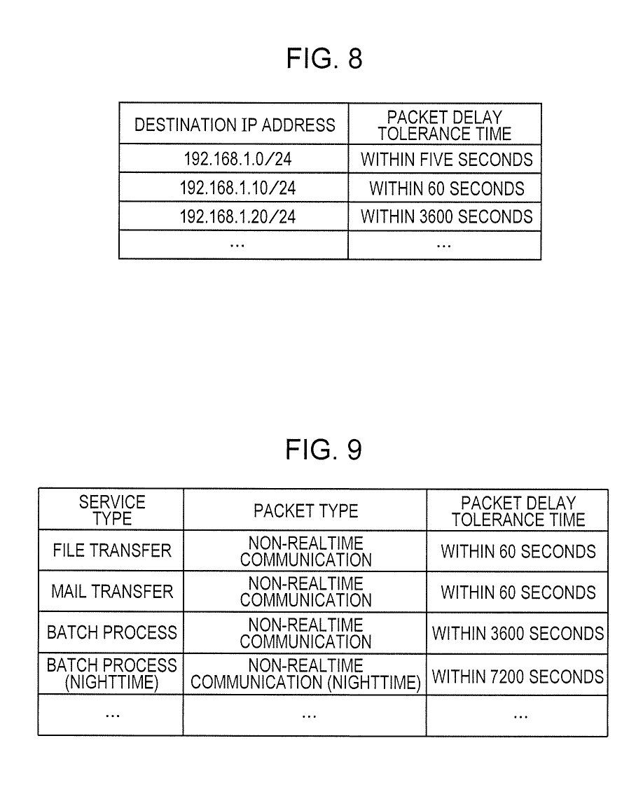

FIG. 7 is a diagram illustrating an example of a packet delay tolerance time assignment policy, according to an embodiment. According to a packet delay tolerance time assignment policy 31 depicted in FIG. 7, a packet delay tolerance time is determined based on an application layer protocol.

In FIG. 7, the packet delay tolerance time for RTP is determined to be within five seconds, the packet delay tolerance times for SMTP and POP3 are determined to be within 60 seconds, and the packet delay tolerance time for FTP is determined to be within 3600 seconds. The packet delay tolerance time assignment policy 31 may be modified in accordance with the operation of a network to be used.

The packet delay tolerance time to be added to a communication packet may also be determined not based on an application layer protocol but based on another decision index.

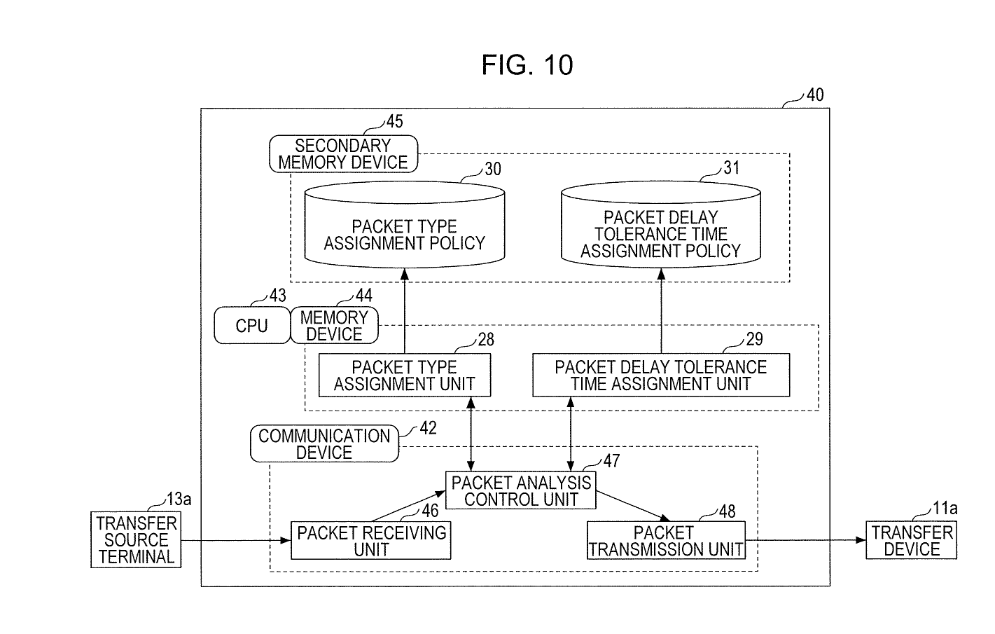

FIG. 8 is a diagram illustrating an example of a packet delay tolerance time assignment policy, according to an embodiment. According to a packet delay tolerance time assignment policy 31 depicted in FIG. 8, the packet delay tolerance time is determined based on a destination IP address.

Further, the packet type assignment policy 30 and the packet delay tolerance time assignment policy 31 may be configured to determine a packet type and a packet delay tolerance time based on a service type that is input by a user and received by the communication request receiving unit 26.

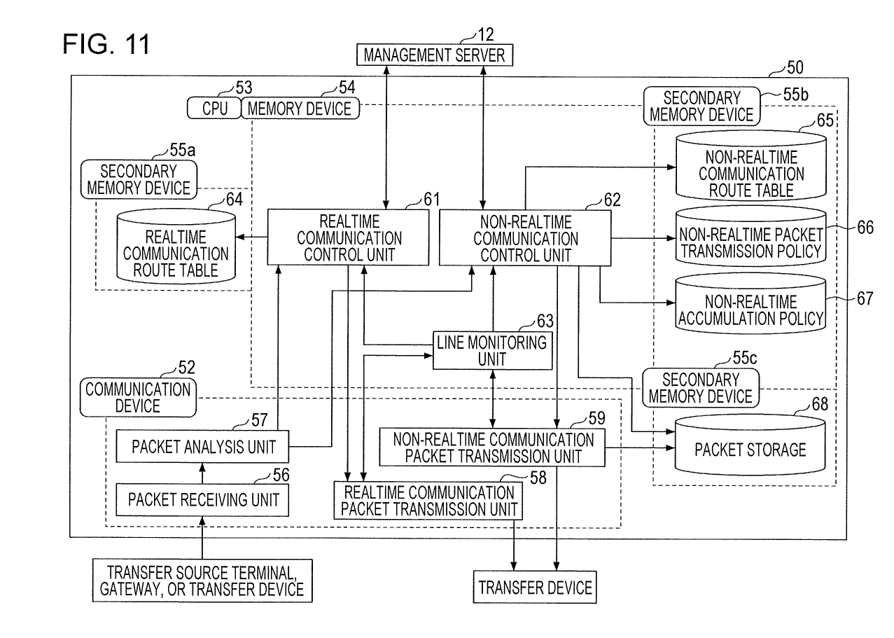

FIG. 9 is a diagram illustrating an example of a packet type assignment policy and a packet delay tolerance time assignment policy, according to an embodiment. According to the packet type assignment policy 30 and the packet delay tolerance time assignment policy 31 depicted in FIG. 9, a service type of file transfer is associated with a packet type of non-realtime communication and a packet delay tolerance time of within 60 seconds. A service type of mail transfer is associated with a packet type of non-realtime communication and a packet delay tolerance time of within 60 seconds. A service type of batch process is associated with a packet type of non-realtime communication and a packet delay tolerance time of within 3600 seconds. Further, a service type of batch process during nighttime is associated with a packet type of non-realtime communication and a packet delay tolerance time of within 7200 seconds.

The packet transmission unit 27 transmits the communication packet received from the communication request receiving unit 26 to the transfer device so that the communication packet is transferred in the network.

<Gateway Device>

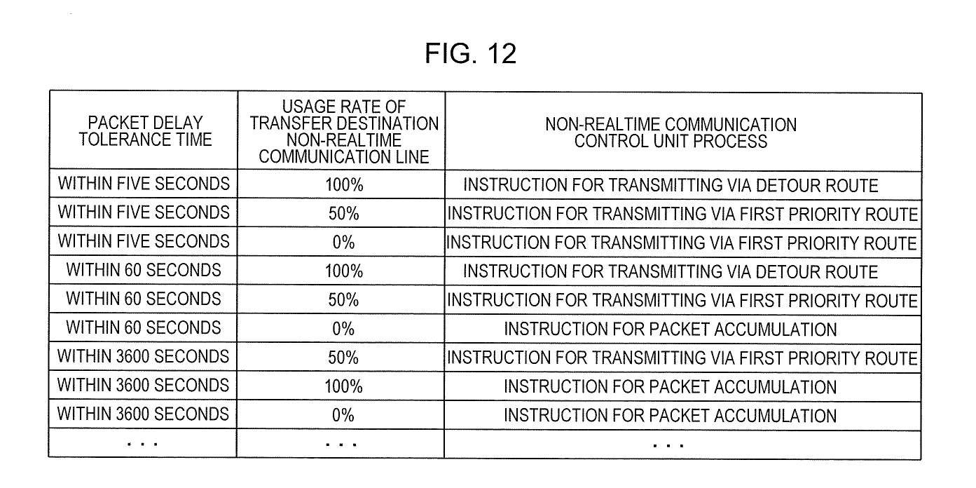

FIG. 10 is a diagram illustrating a configuration example of a gateway device, according to an embodiment. A gateway device 40 depicted in FIG. 10 corresponds to the gateway 15a, and includes, as a hardware configuration, a communication device 42, a CPU 43, a memory device 44, and a secondary memory device 45.

The communication device 42 includes a packet receiving unit 46, a packet analysis control unit 47, and a packet transmission unit 48. The packet receiving unit 46 receives a communication packet from the transfer source terminal and requests the packet analysis control unit 47 to analyze the communication packet.

The CPU 43 functions as the packet type assignment unit 28 and the packet delay tolerance time assignment unit 29 by executing a program stored in the memory device 44. The secondary memory device 45 stores the packet type assignment policy 30 and the packet delay tolerance time assignment policy 31. Each of the packet type assignment unit 28, the packet delay tolerance time assignment unit 29, the packet type assignment policy 30, and the packet delay tolerance time assignment policy 31 has the same configuration as that of FIG. 5.

The packet analysis control unit 47 analyzes the communication packet received from the packet receiving unit 46 and requests the packet type assignment unit 28 and the packet delay tolerance time assignment unit 29 to add a packet type and a packet delay tolerance time to the communication packet. The packet analysis control unit 47 does not carry out the above request to the packet type assignment unit 28 and the packet delay tolerance time assignment unit 29 when the communication packet received from the packet receiving unit 46 has been already provided with a packet type and a packet delay tolerance time. After the packet type and the packet delay tolerance time are added to the communication packet, the packet analysis control unit 47 sends the communication packet to the packet transmission unit 48.

The packet type assignment unit 28 adds a packet type to the communication packet according to the packet type assignment policy 30 and sends the communication packet provided with the packet type to the packet analysis control unit 47. In the packet type assignment policy 30, a packet type is identified based on, for example, an application layer protocol.

The packet delay tolerance time assignment unit 29 adds a packet delay tolerance time to the communication packet according to the packet delay tolerance time assignment policy 31 and sends the communication packet provided with the packet delay tolerance time to the packet analysis control unit 47.

The packet transmission unit 48 transmits the communication packet received from the packet analysis control unit 47 to the transfer device so that the communication packet is transferred on the network.

<Transfer Device>

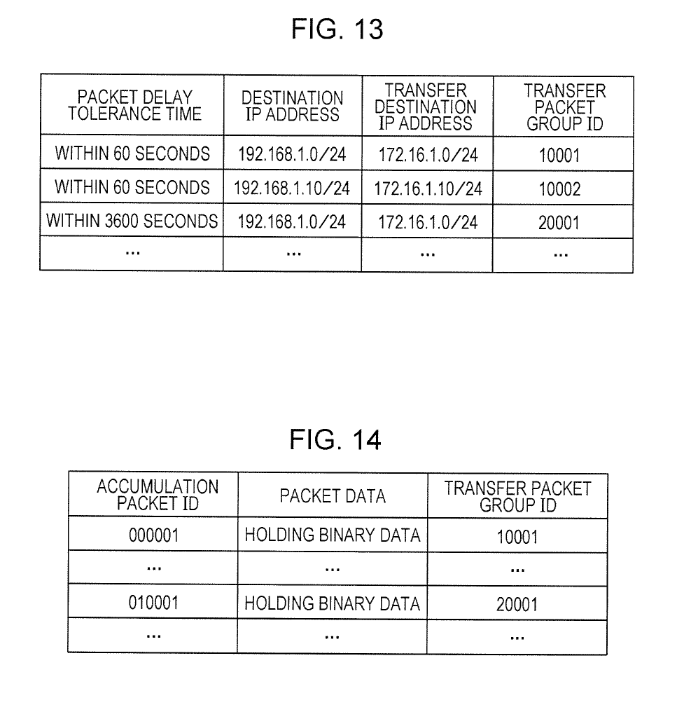

FIG. 11 is a diagram illustrating a configuration example of a transfer device, according to an embodiment. A transfer device 50 depicted in FIG. 11 corresponds to the transfer device 11a, and includes, as a hardware configuration, a communication device 52, a CPU 53, a memory device 54, and secondary memory devices 55a, 55b, 55c.

The communication device 52 includes a packet receiving unit 56, a packet analysis unit 57, a realtime communication packet transmission unit 58, and a non-realtime communication packet transmission unit 59. The packet receiving unit 56 receives a communication packet from the transfer source terminal or another transfer device and requests the packet analysis unit 57 to analyze the communication packet.

The packet analysis unit 57 determines whether the communication packet is a packet for the realtime communication or a packet for the non-realtime communication based on the packet type added to the communication packet received from the packet receiving unit 56. The packet analysis unit 57 sends the communication packet to a realtime communication control unit 61 in the case of the realtime communication and sends the communication packet to a non-realtime communication control unit 62 in the case of the non-realtime communication.

The CPU 53 functions as the realtime communication control unit 61, the non-realtime communication control unit 62, and a line monitoring unit 63 by executing a program stored in the memory device 54. A realtime communication route table 64 is stored in the secondary memory device 55a. A non-realtime communication route table 65, a non-realtime packet transmission policy 66, and a non-realtime accumulation policy 67 are stored in the secondary memory device 55b. The secondary memory device 55c is used as a packet storage 68 for accumulating communication packets that are transmitted as the non-realtime communication. The packet storage 68 is also called as an accumulation unit.

The realtime communication control unit 61 receives the communication packet from the packet analysis unit 57, determines a transfer destination route of the communication packet from among routes obtained by referring to the realtime communication route table 64, and instructs the realtime communication packet transmission unit 58 to transfer the communication packet.

Upon receiving, from the packet analysis unit 57, a route setting request for setting a route for realtime communication, the realtime communication control unit 61 transmits the route setting request to the management server 12. In response to the route setting request, the management server 12 creates a route for realtime communication and transmits information on the created route for realtime communication to the realtime communication control unit 61 in every transfer device along the route. The realtime communication control unit 61 stores the received information regarding the route for realtime communication in the realtime communication route table 64.

The line monitoring unit 63 periodically obtains available bandwidth capacity of lines for realtime communication from the realtime communication packet transmission unit 58, and informs the realtime communication control unit 61 of the available bandwidth capacity of the lines. The line monitoring unit 63 also periodically obtains the available bandwidth capacity of lines for non-realtime communication from the non-realtime communication packet transmission unit 59, and informs the non-realtime communication control unit 62 of the available bandwidth capacity of the lines.

The non-realtime communication control unit 62 receives communication packets from the packet analysis unit 57 and accumulates the communication packets in the packet storage 68 according to the non-realtime accumulation policy 67. It is noted that, when a packet delay tolerance time provided with a communication packet is smaller than a threshold (for example, five seconds), the non-realtime communication control unit 62 does not accumulate the communication packet in the packet storage 68 but, as described later, determines a transfer destination route of the communication packet from among routes obtained by referring to the non-realtime communication route table 65 and instructs the non-realtime communication packet transmission unit 59 to transfer the communication packet to the determined transfer destination route.

Upon receiving a route setting request for the non-realtime communication from the packet analysis unit 57, the non-realtime communication control unit 62 transmits the route setting request to the management server 12. In response to the route setting request, the management server 12 creates a route for non-realtime communication and transmits information on the created route for realtime communication to the non-realtime communication control unit 62 in every transfer device along the route. The non-realtime communication control unit 62 stores the received information regarding the route for realtime communication, in the non-realtime communication route table 65.

As for a communication packet accumulated in the packet storage 68, a time period during which the communication packet has been stored in the packet storage 68 is subtracted from the packet delay tolerance time added to the communication packet.

In response to a communication packet for the non-realtime communication, which has been received by the packet receiving unit 56, the non-realtime communication control unit 62 obtains a next transfer destination for each of first to n-th priority routes by referring to the non-realtime communication route table 65 using the transmission source address and the transmission destination address of the received communication packet, and obtains, from the line monitoring unit 63, the state of a transmission route for the next transfer destination. Thereafter, the non-realtime communication control unit 62 refers to the non-realtime packet transmission policy 66 using the packet delay tolerance time of the received communication packet to determine a process to be performed on the received communication packet.

For each communication packet accumulated in the packet storage 68, the non-realtime communication control unit 62 refers, at regular intervals, to the non-realtime communication route table 65 using the transmission source address and the transmission destination address of the each communication packet, and obtains a next transfer destination for each of the first to n-th priority routes. After obtaining the state of a transmission route for the next transfer destination from the line monitoring unit 63, the non-realtime communication control unit 62 determines a process to be performed on the communication packet, by referring to the non-realtime packet transmission policy 66.

The non-realtime communication control unit 62 instructs the non-realtime communication packet transmission unit 59 to transfer the communication packet, by sending the communication packet to the non-realtime communication packet transmission unit 59.

<Non-Realtime Packet Transmission Policy>

The non-realtime packet transmission policy 66 is a policy for determining a process to be performed by the non-realtime communication control unit 62, based on the packet delay tolerance time of the communication packet and the usage rates of lines that are used for non-realtime communication to a transfer destination. The non-realtime packet transmission policy 66 may be modified in accordance with the operation of the network.

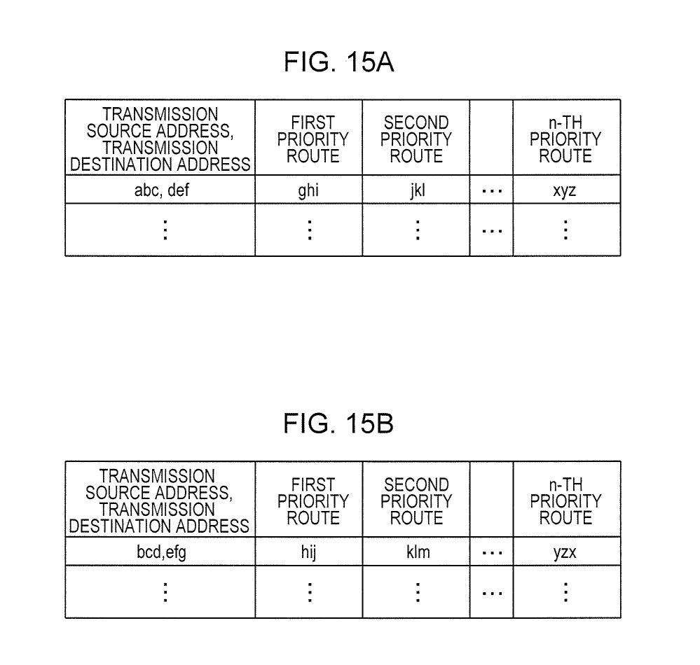

FIG. 12 is a diagram illustrating an example of a non-realtime packet transmission policy, according to an embodiment. In a non-realtime packet transmission policy 66 depicted in FIG. 12, information item “packet delay tolerance time” corresponds to the packet delay tolerance time added to a communication packet. Information item “usage rate of transfer destination non-realtime communication line” is a reference value for the usage rate of a communication line used for non-realtime communication to the transfer destination, from which it is determined whether there exists available bandwidth capacity for transferring additional data left in the transmission route including the line. Information item “non-realtime communication control unit process” indicates a process to be executed by the non-realtime communication control unit 62.

For example, when the packet delay tolerance time added to a communication packet is within five seconds and the usage rate of the line along a transmission route for transferring the communication packet is 100%, the non-realtime communication control unit 62 issues a route reconstruction request for reconstructing a transmission route, to the management server 12. When the packet delay tolerance time added to a communication packet is within five seconds and the usage rate of the line along a transmission route for transferring the communication packet is 50%, the non-realtime communication control unit 62 issues a packet transfer instruction. When the packet delay tolerance time added to a communication packet is within 60 seconds and the usage rate of the line along the transmission route for transferring the communication packet is 0%, that is, the transfer device at the transfer destination is stopping, the non-realtime communication control unit 62 issues an instruction for keeping packet accumulation.

<Non-Realtime Accumulation Policy>

The non-realtime accumulation policy 67 is a policy for determining a packet group to be transferred, based on the packet delay tolerance time, a destination IP address, and a transfer destination IP address of the communication packet. The non-realtime accumulation policy 67 may be modified in accordance with the operation of the network.

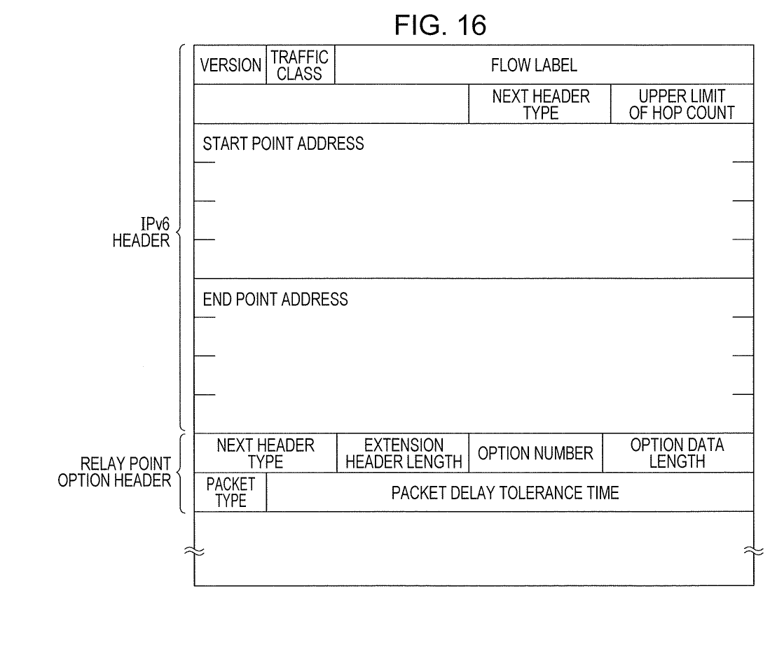

FIG. 13 is a diagram illustrating an example of a non-realtime accumulation policy, according to an embodiment. In a non-realtime accumulation policy 67 depicted in FIG. 13, information item “packet delay tolerance time” indicates a packet delay tolerance time added to the communication packet. Information items “destination IP address” and “transfer destination IP address” indicate the destination IP address and the transfer destination IP address of the communication packet, respectively. Information item “transfer packet group ID” is a group ID identifying a communication packet group that is to be controlled when issuing a route setting request to the management server or when transmitting communication packets collectively.

For example, the transfer packet group ID “10001” is assigned to a packet group in which the packet delay tolerance time added to a communication packet is within 60 seconds, the destination IP address is “192.168.1.0/24”, and the transfer destination IP address is “172.16.1.0/24”.

The packet storage 68 holds whole the data of a communication packet to be transferred by assigning an accumulation packet ID to the communication packet to be accumulated. At that time, the transfer packet group ID defined in the non-realtime accumulation policy 67 is also held together.

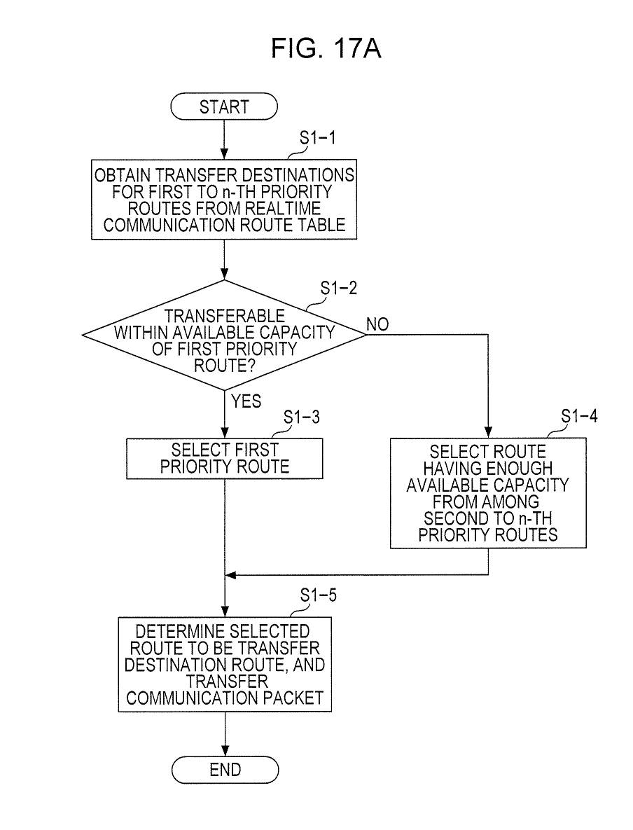

FIG. 14 is a diagram illustrating an example of information stored in a packet storage, according to an embodiment. In a packet storage 68 depicted in FIG. 14, for example, “000001” is given as an information item “accumulation packet ID”, binary data of the transferred packet is held as an information item “packet data”, and “10001” is held as an information item “transfer packet group ID”

The realtime communication packet transmission unit 58 transfers the communication packet received from the realtime communication control unit 61 to the next transfer device using a realtime communication line.

The non-realtime communication packet transmission unit 59 obtains, from the packet storage 68, the communication packet that has been instructed to transmit by the non-realtime communication control unit 62, and transfers the communication packet to a next transfer device using a non-realtime communication line. In the case, the non-realtime communication packet transmission unit 59 subtracts a duration time during which the communication packet has been stored in the packet storage 68, from the packet delay tolerance time added to the communication packet when extracting the communication packet from the packet storage 68.

<Realtime Communication Route Table and Non-Realtime Communication Route Table>

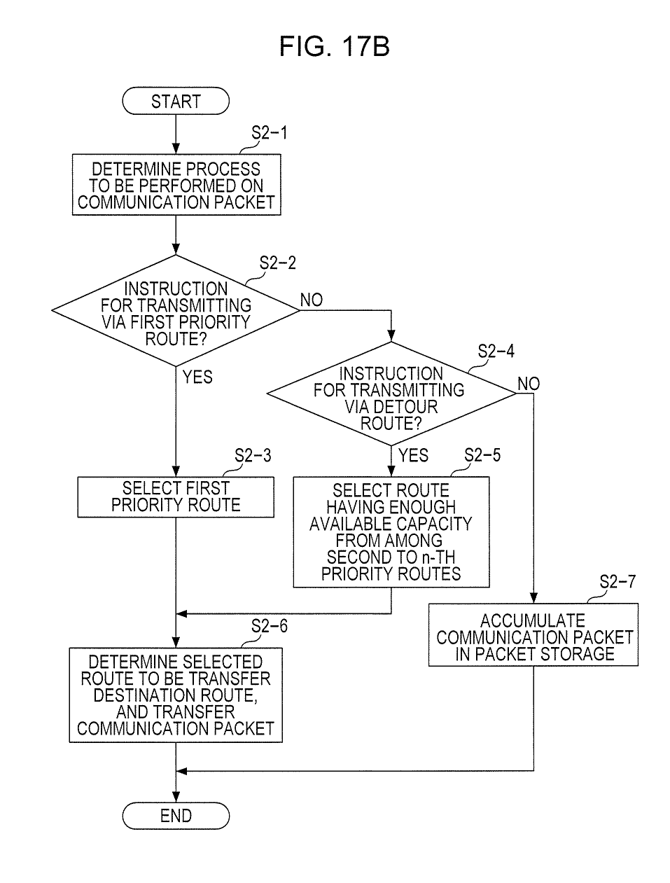

FIG. 15A is a diagram illustrating an example of a realtime communication route table, according to an embodiment, and FIG. 15B is a diagram illustrating an example of a non-realtime communication route table, according to an embodiment. In each of the realtime communication route table 64 and the non-realtime communication route table 65 depicted in FIGS. 15A and 15B, next transfer destinations for the first to n-th priority routes are set for each transmission source address and transmission destination address. The transmission source address, the transmission destination address, and the information on the next transfer destinations for the respective priority routes are supplied from the management server 12 and set to each of the transfer devices in the network. In the case, although a next transfer destination for the first priority route is indispensable, next transfer destinations for the second to n-th priority routes may be set as needed basis.

<Format of Transferred Packet>

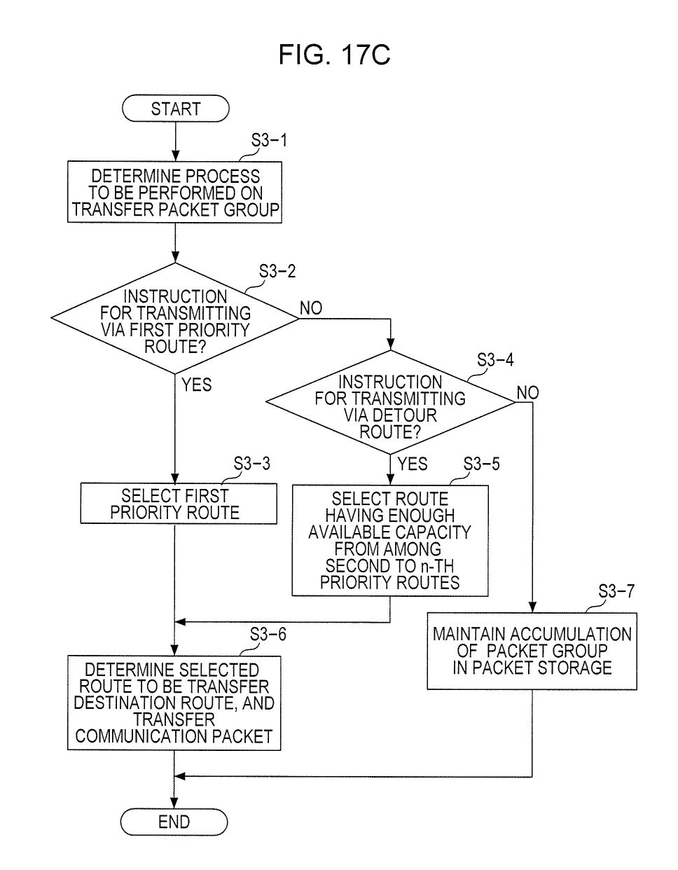

FIG. 16 is a diagram illustrating an example of a data format of an IPv6 (internet protocol version 6) packet as a communication packet to be transferred. In FIG. 16, a relay point option header is used to add a packet type and a packet delay tolerance time to an IPv6 packet. Therefore, the next header type of an IPv6 header is determined to be a relay point option header (value of 0). The extension header length for the relay point option header is determined to be 64 bits (value of 0). The option number is determined to be a value of 1 so as to allow a value of a delay tolerance time to be updated by the transfer device. The option data length is determined to be four bites (value of 4) for a combination of the packet type and the packet delay tolerance time. The data length for the packet type is determined to be four bits whose values 0, 1, and 2 represent a realtime communication packet, a non-realtime communication packet, and a non-realtime communication packet during nighttime, respectively. The data length for the packet delay tolerance time is determined to be 28 bits in which the packet delay tolerance time is stored, for example, on the second time scale. The packet delay tolerance time is subjected to subtraction of a duration time during which the packet has been accumulated in the packet storage.

<Packet Sending Process in Realtime Communication Control Unit and Non-Realtime Communication Control Unit>

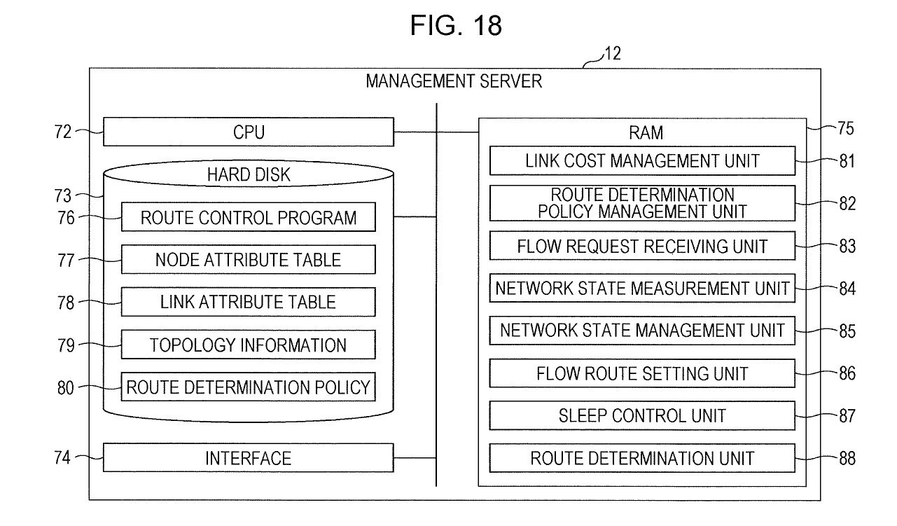

FIG. 17A is a diagram illustrating an example of an operational flowchart for transmitting a communication packet for realtime communication, according to an embodiment. FIG. 17A illustrates packet transmission process performed by the realtime communication control unit 61 when the transfer device 50 receives a communication packet for realtime communication.

In operation S1-1, upon receiving a communication packet for realtime communication from the packet analysis unit 57, the realtime communication control unit 61 obtains transfer destinations for the first to n-th priority routes, by referring to the realtime communication route table 64 using the transmission source address and the transmission destination address of the communication packet.

In operation S1-2, the realtime communication control unit 61 determines whether or not the communication packet is transferable within the available capacity of the first priority route, where the available capacity is periodically detected by the line monitoring unit 63.

In operation S1-3, the realtime communication control unit 61 selects the first priority route when the communication packet is transferable within the available capacity of the first priority route (YES in operation S1-2).

In operation S1-4, the realtime communication control unit 61 selects, from among the second to n-th priority routes, a route having the available capacity enough for transferring the communication packet, that is, a detour route for the communication packet, when the communication packet is not transferable within the available capacity of the first priority route (NO in operation S1-2).

In operation S1-5, the realtime communication control unit 61 determines the selected route to be a transfer destination route of the communication packet, and instructs the realtime communication packet transmission unit 58 to transfer the communication packet.

FIG. 17B is a diagram illustrating an example of an operational flowchart for transmitting a communication packet for non-realtime communication, according to an embodiment. FIG. 17B illustrates packet transmission process performed by the non-realtime communication control unit 62 when the transfer device 50 receives a communication packet for non-realtime communication.

In operation S2-1, upon receiving a communication packet for non-realtime communication from the packet analysis unit 57, the non-realtime communication control unit 62 obtains next transfer destinations for the first to n-th priority routes, by referring to the non-realtime communication route table 65 using the transmission source address and the transmission destination address of the communication packet. Then, the non-realtime communication control unit 62 obtains, from the line monitoring unit 63, the state of the first priority route as the next transfer destination, and determines process to be performed on the communication packet by referring to the non-realtime packet transmission policy 66 using the packet delay tolerance time of the received communication packet.

In operation S2-2, the non-realtime communication control unit 62 determines whether or not an instruction for transmitting via the first priority route is given.

In operation S2-3, the non-realtime communication control unit 62 selects the first priority route when the instruction for transmitting via the first priority route is given (YES in operation S2-2), and goes on to operation S2-6.

In operation S2-4, the non-realtime communication control unit 62 determines whether or not an instruction for transmitting via a detour route is given, that is, whether or not the packet delay tolerance time for the received communication packet is tight, when the instruction for transmitting via the first priority route is not given (NO in operation S2-2).

In operation S2-5, the non-realtime communication control unit 62 selects, from among the second to n-th priority routes, a detour route having an available capacity enough for transferring the communication packet, when the instruction for transmitting via a detour route is given (YES in operation S2-4), and goes on to operation S2-6.

In operation S2-6, the non-realtime communication control unit 62 determines the selected route (the first priority route or the detour route) to be the transfer destination route of the communication packet, and instructs the non-realtime communication packet transmission unit 59 to transfer the communication packet.

In operation S2-7, the non-realtime communication control unit 62 accumulates the communication packet in the packet storage 68 when the instruction for transmitting via a detour route is not given (NO in operation S2-4), that is, when the instruction for accumulating the communication packet is given.

Instead of performing the above packet transmission process illustrated in FIG. 17B, it is also possible to accumulate all the received communication packets for non-realtime communication, in the packet storage 68, and to transmit the communication packets by packet transmission process in FIG. 17C which will be described below.

FIG. 17C is a diagram illustrating an example of an operational flowchart for transmitting a communication packet from a packet storage, according to an embodiment. FIG. 17C illustrates process that is performed at regular intervals by the non-realtime communication control unit 62 so as to transmit a communication packet from a packet storage.

In operation S3-1, the non-realtime communication control unit 62 obtains next transfer destinations for the first to n-th priority routes, by referring to the non-realtime communication route table 65 using the transmission source address and the transmission destination address of a communication packet of a transfer packet group that is included in the communication packets accumulated in the packet storage 68 and is to be transferred collectively. Then, after obtaining, from the line monitoring unit 63, the route state for the next transfer destination of the first priority route, the non-realtime communication control unit 62 determines process to be performed on the transfer packet group by referring to the non-realtime packet transmission policy 66 using a packet delay tolerance time that is minimum within the transfer packet group.

In operation S3-2, the non-realtime communication control unit 62 determines whether or not an instruction for transmitting via the first priority route is given. When the instruction for transmitting via the first priority route is given (YES in operation S3-2), in operation S3-3, the non-realtime communication control unit 62 selects the first priority route and goes on to operation S3-6. Meanwhile, when the instruction for transmitting via the first priority route is not given (NO in operation S3-2), in operation S3-4, the non-realtime communication control unit 62 determines whether or not an instruction for transmitting via a detour route is given, that is, whether or not the packet delay tolerance time for the received communication packet is tight.

When the instruction for transmitting via a detour route is given (YES in operation S2-4), in operation S3-5, the non-realtime communication control unit 62 selects, from among the second to n-th priority routes, a detour route having an available capacity enough for transferring the transfer packet group, and goes on to operation S3-6.

In operation S3-6, the non-realtime communication control unit 62 determines the selected route (the first priority route or the detour route) to be the transfer destination route of the transfer packet group, and instructs the non-realtime communication packet transmission unit 59 to transfer the communication packets included in the transfer packet group.

Meanwhile, when the instruction for transmitting via a detour route is not given but the instruction for packet accumulation is given (NO in operation S3-4), in operation S3-7, the non-realtime communication control unit 62 maintains accumulation of the transfer packet group in the packet storage 68.

According to the operations described above, a communication packet is transferred within the delay tolerance time while using a power saving route as much as possible.

<Management Server>

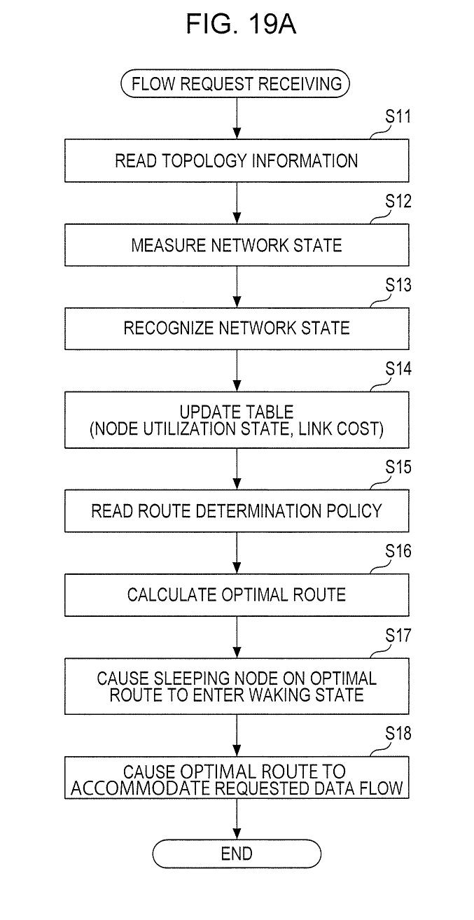

FIG. 18 is a diagram illustrating a configuration example of a management server, according to an embodiment. In FIG. 18, a management server 12 is connected to each of a plurality of transfer devices that are communicably coupled to each other via links to configure a network. The management server 12 monitors the state of each transfer device and controls the respective transfer devices so as to set a transmission route for a data flow. The management server 12 is implemented by installing a route control program 76 in a hard disk 73 of a computer having a normal hardware configuration and by causing a CPU 72 to read out respective program modules 81 through 88 configuring the route control program 76 into a RAM 75 and to execute them. The CPU 72, the hard disk 73, and the RAM 75 described above are connected to each other, for example, via a bus, together with an interface 74 connected to each transfer device.

The respective program modules 81 through 88 configuring the route control program 76 described above are, respectively, a link cost management unit 81, a route determination policy management unit 82, a flow request receiving unit 83, a network state measurement unit 84, a network state management unit 85, a flow route setting unit 86, a sleep control unit 87, and a route determination unit 88.

The network state management unit 85 stores topology information 79 representing a network topology in the hard disk 73 and manages the topology information 79, where the network topology indicates how the respective transfer devices are connected to each other through links. The network state management unit 85 also stores a node attribute table 77 in the hard disk 73 and manages the node attribute table 77, where a node means a transfer device and the node attribute table 77 stores a utilization situation (sleeping: 0, waking: 1) sensed by the network state measurement unit 84 and power consumption, in association with each transfer device.

The network state measurement unit 84 examines the utilization state of each transfer device to inform the network state management unit 85 of the examination results. The network state measurement unit 84 also measures and aggregates the states of a traffic flow in a link connecting each pair of transfer devices included in a plurality of transfer devices in the network, for each of the realtime communication and the non-realtime communication. The aggregated measured values for the states of a traffic flow in each link are sent to the network state management unit 85. Then, the network state management unit 85 stores, in a link attribute table 78 in the hard disk 73 as a memory unit, the measured values for the states of a traffic flow in the network or the traffic state values estimated based on a history of measurements for a certain period of time in the past, which have been aggregated for each of the realtime communication and the non-realtime communication and transmitted from the network state measurement unit 84.

The link attribute table 78 is a table in which a link attribute is registered for each of links connecting the transfer devices or connecting a transfer device at the end and a terminal. This link attribute includes, for each of the links, information items: “flow destination node”, “power consumption (kW)”, “traffic volume (Gbps)”, “link upper limit constraint and physical bandwidth (Gbps)”, “remaining capacity (Gbps)”, “presence of link utilization”, and “link cost”. It is noted that the unit of each information item is determined by a policy of the operator.

The “flow destination node” is a node number assigned to a node as a flow destination for each link. Even in a case where each pair of transfer devices is connected using physically one resource (cable), up and down data links included in the link are handled separately. Accordingly, in order to identify each of the up and down data links, a link number and a flow destination node is defined for each of the data links.

The “power consumption” indicates power consumption that occurs for the link itself when using the link, for example, power consumption of a physical resource.

The “traffic volume” is a sum total of traffic volumes of all dataflow paths that are set on the link, and is managed for each of the realtime communication and the non-realtime communication.

The “link upper limit constraint” is an upper limit of the sum total of traffic volumes of the dataflow paths that are allowed to be set on the link, and is managed for each of the realtime communication and the non-realtime communication.

The “physical bandwidth” indicates a bandwidth that is allowed to be accommodated by a physical resource of the link, and is managed for each of the realtime communication and the non-realtime communication.

The “remaining capacity” is the remainder obtained by subtracting the above value of “traffic volume” from the above value of “link upper limit constraint”, that is, the traffic volume of the dataflow paths that are further allowed to be set on the link, and is managed for each of the realtime communication and the non-realtime communication.

The value of the “presence of link utilization” is set at “0” in the case where no dataflow paths are being set on the link, and ser at “1” in the case where at least one dataflow path is being set on the link.

The “link cost” indicates power consumption that is defined in a node table in association with the above “flow destination node”. In the embodiment, the “link cost” is obtained based on power consumption that is consumed by each node to achieve the individual data flow in such a manner that power consumption of a node k is assigned to all links X_{h, k}, X_{i, k}, X_{j, k} via which data flow from other nodes h, i, j to the node k, as the respective link costs L_{h, k}, L_{i, k}, L_{j, k}. This allows the power consumption for a transmission route to be obtained by calculating the sum total of link costs for links along the transmission route. In addition, “δ (iota)” is used as a constant value that is sufficiently small compared to the original power consumption, and the information item “link cost” is, under some conditions, overwritten with “δ (iota)” instead of the power consumption of the flow destination node, as will be described later. That is, the “δ” is a value equivalent to the power consumption that is increased when one dataflow path is additionally set to a node in a waking state, for example, a value obtained by multiplying the original power consumption by a ratio of about one ten-thousandth, or a constant close to the obtained value.

The link cost management unit 81 manages the “link cost” for each link in the link attribute table 78.

The flow request receiving unit 83 receives, from the terminal placed in each site, a request for setting a dataflow path (hereinafter, referred to as “flow request”) including a request for desired bandwidth to carry out communication to a specific destination.

The route determination policy management unit 82 stores, in the hard disk 73, a route determination policy 80, and manages the route determination policy 80. The route determination policy 80 includes constraint conditions for setting a dataflow path, which are referred to when the route determination unit 88 described later determines a dataflow path in response to a flow request received by the flow request receiving unit 83. The route determination policy 80 may be configured to include, as the constraint conditions, for example, a path length (hop count) condition that defines an upper limit of the number of links to be set between a pair of terminals performing communication with each other, and a remaining capacity condition that requests a sum total of the traffic volume of the dataflow paths set in a certain link to be equal to or less than the value of “link upper limit constraint” registered in the link attribute table 78.

The route determination unit 88 determines a link-cost minimum route that has a minimum sum total of the link costs, under the constraint conditions included in the route determination policy 80, as a route along which a dataflow path is to be set from a request source terminal to a destination terminal in response to the flow request received by the flow request receiving unit 83.

The flow route setting unit 86 sets, for each flow request, the route determined by the route determination unit 88, on the network. In other words, each transfer device is controlled in such a manner that a dataflow path determined based on each flow request is set along the determined route.

When the flow route setting unit 86 sets a route for a dataflow path on a network, the sleep control unit 87 executes control so that when there exists a node in a sleeping state along the route, the node in a sleeping state is forced to enter a waking state, and when all the dataflow paths passing through a certain node have been released, the certain node is forced to enter a sleeping state so as to be released.

<Route Control Process>

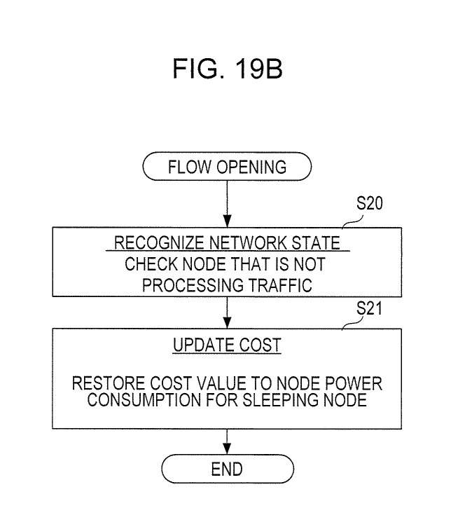

Next, a description will be given of a procedure of operations executed by the CPU 72 based on the route control program 76 that is configured from the modules 81 through 88 described above, with reference to operational flowcharts in FIGS. 19A and 19B. The procedure illustrated in each of FIGS. 19A and 19B is executed separately for each of the realtime communication and the non-realtime communication.

FIG. 19A is a diagram illustrating an example of an operational flowchart performed by a route control program of a management server, according to an embodiment. The operational flowchart illustrated in FIG. 19A is invoked each time the management server 12 receives a flow request from any one of terminals.

In operation S11, the network state management unit 85 reads the topology information 79 from the hard disk 73.

In operation S12, the network state measurement unit 84 measures network states, such as the utilization state of each transfer device on the network and the state of a traffic flow in each link. Alternately, for example, the network states may be estimated from the history of setting dataflow up to now.

In operation S13, the network state management unit 85 recognizes the current state of the network based on the network states measured in operation S12.

In operation S14, the network state management unit 85 and the link cost management unit 81 update the node attribute table 77 and the link attribute table 78 based on the current state of the network recognized in operation S13. For example, when there is a transfer device in a waking state, the network state management unit 85 changes the value of node utilization state of the transfer device in the node attribute table 77 to “1”, and also the link cost management unit 81 changes the value of link costs, in the link attribute table 78, for all links via which data flow into the transfer device to “δ”. It is noted that, when each value has been already changed at the time of performing the operation S14, the network state management unit 85 and the link cost management unit 81 do not carry out further updates.

In operation S15, the route determination policy management unit 82 reads the route determination policy 80 from the hard disk 73.

In operation S16, the route determination unit 88 executes calculation to determine an optimal route for a dataflow path between the request source terminal and the destination terminal requested by the flow request. That is, on the assumption that all links are available, the route determination unit 88 determines, for each of all the possible candidates for the optimal route, whether or not the constraint conditions included in the route determination policy 80 are satisfied, and when any one of constraint conditions is not satisfied for a route, the route is removed from the candidates for the optimal route. Here, with respect to the remaining capacity condition, it is determined that the remaining capacity condition is not satisfied when there is no remaining capacity left in at least one link. Then, for all the remaining candidates for the optimal route, an objective function MIN{ΣᵢΣⱼL_{i, j}} is executed where L_{i, j} denotes a link cost of a link via which data flow from the node i to the node j.

For example, the route determination unit 88 determines a first candidate route having the smallest sum total of link costs as a candidate for the optimal route, based on the sum total of link costs that are registered in the link attribute table 78 in association with the respective links configuring the candidates for the optimal route. In the case, when the minimum value of the remaining available capacity of links along the first candidate route is below the required bandwidth, in addition to the first candidate route, the route determination unit 88 further determines a second candidate route having the sum total of link costs that is small next to that of the first candidate route, as a next candidate for the optimal route. In this way, a plurality of routes satisfying the required bandwidth capacity may be determined finally. As a result of executing the objective function and performing determination based on the constraint conditions, one or more routes that satisfy each constraint condition are determined in increasing order of the sum total of link costs, and the process goes on to operation S17. Among the determined one or more routes, a route that has been firstly determined is referred to as a first priority route and becomes the optimal route. A route that has been secondly determined is referred to as a second priority route, and third to n-th priority routes may be determined in the similar manner as mentioned above.

In operation S17, the sleep control unit 87 reads, from the node attribute table 77, the node utilization states of transfer devices along the optimal route determined in operation S16, and causes the transfer devices in a sleeping state to enter a waking state.

In next operation S18, the flow route setting unit 86 causes the optimal route determined in operation S16 to accommodate a dataflow path for communication requested by the flow request. In other words, the transfer functions of all nodes on the optimal route are set in such a manner that data requested by the flow request are transferred through the determined optimal route. As described above, the process illustrated by the operational flowchart of FIG. 19A is completed.

FIG. 19B is a diagram illustrating an example of an operational flowchart performed by a route control program of a management server, according to an embodiment. The process illustrated in FIG. 19B is invoked as interrupt operation at regular intervals.

In operation S20, the network state measurement unit 84 measures or estimates the network state, and based on the results, the network state management unit 85 recognizes the network state and checks whether there exists a node that is in a waking state but is not processing any traffic at all.

In operation S21, when there exists a node that is in a waking state without processing any traffic, the sleep control unit 87 causes the node to enter a sleeping state, and the link cost management unit 81 restores the values of link costs for all the links via which data flow into the node, from “δ” to the original node power consumption. As described above, the process illustrated by the operational flowchart of FIG. 19B is completed.

<Communication Packet Process Sequence in Transfer Source Terminal>

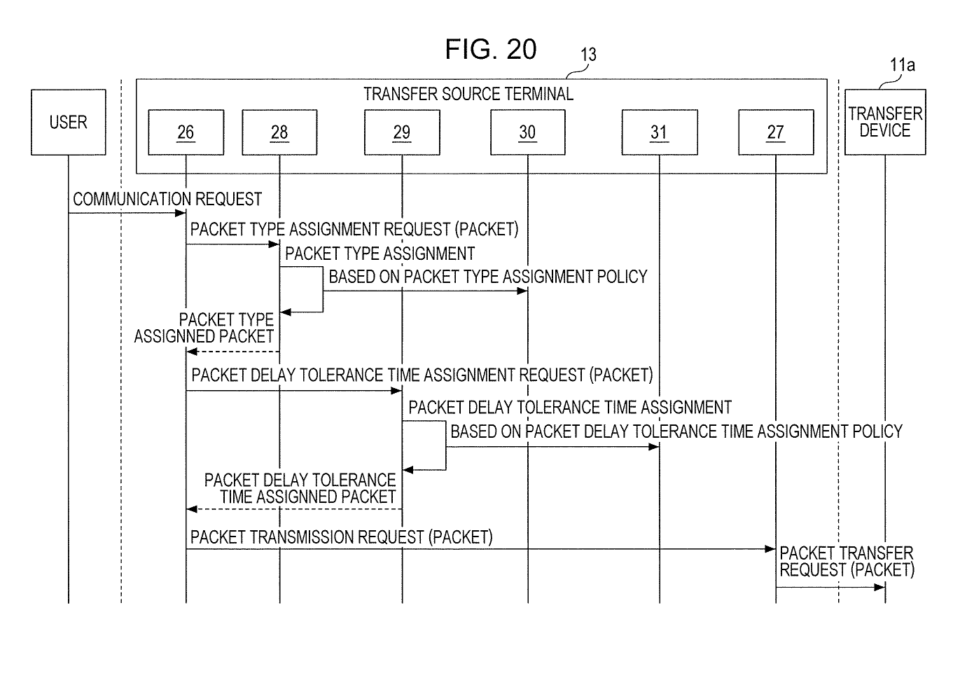

FIG. 20 is a diagram illustrating an example of an operational sequence for processing a communication packet in a transfer source terminal, according to an embodiment. FIG. 20 illustrates an operational sequence for processing a communication packet in a transfer source terminal 13. In FIG. 20, upon receiving a communication request from a user, the communication request receiving unit 26 requests the packet type assignment unit 28 to add a packet type to the communication packet. Further the communication request receiving unit 26 requests the packet delay tolerance time assignment unit 29 to add a packet delay tolerance time to the communication packet. After that, the communication request receiving unit 26 sends the communication packet provided with both the packet type and the packet delay tolerance time to the packet transmission unit 27. The packet transmission unit 27 transmits the communication packet to a transfer device.

<Communication Packet Process Sequence of Gateway Device>

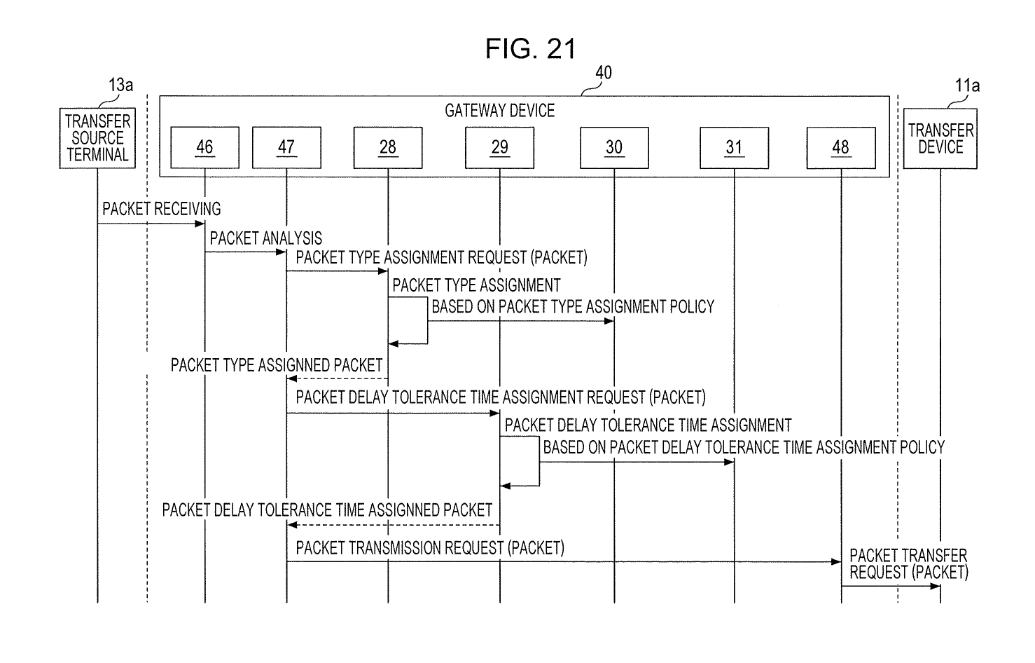

FIG. 21 is a diagram illustrating an example of an operational sequence for processing a communication packet in a gateway device, according to an embodiment. FIG. 21 illustrates a communication packet process sequence in a gateway device 40. In FIG. 21, the packet receiving unit 46 receives a communication packet from the transfer source terminal 13a and requests the packet analysis control unit 47 to analyze the communication packet. The packet analysis control unit 47 requests the packet type assignment unit 28 to add a packet type to the communication packet. Further, the packet analysis control unit 47 requests the packet delay tolerance time assignment unit 29 to add a packet delay tolerance time to the communication packet. After that, the packet analysis control unit 47 sends the communication packet provided with both the packet type and the packet delay tolerance time to the packet transmission unit 48. The packet transmission unit 48 transmits the communication packet to a transfer device.

<Receiving and Sending or Accumulation Process Sequence of Transfer Device>

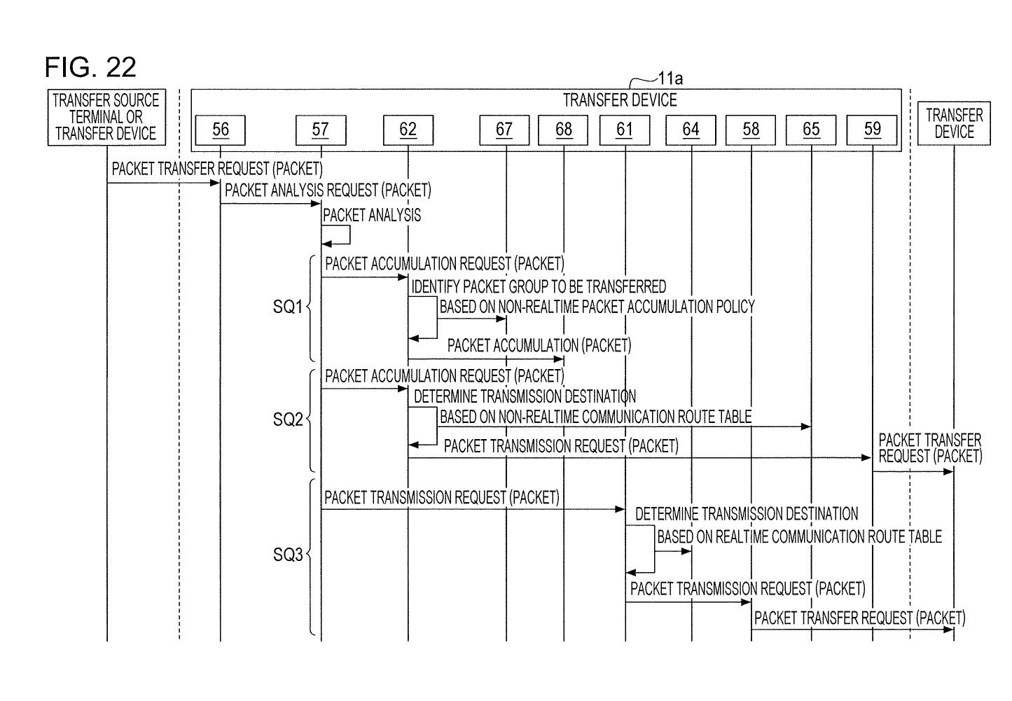

FIG. 22 is a diagram illustrating an example of an operational sequence for processing a communication packet in a transfer device, according to an embodiment. FIG. 22 illustrates a receiving, transmitting, and accumulation process sequence of a communication packet in the transfer device 11a. In FIG. 22, the packet receiving unit 56 receives a communication packet, for example, from the transfer source terminal 13a and requests the packet analysis unit 57 to analyze the communication packet.

When, the communication packet is for non-realtime communication and has an enough delay tolerance time that is equal to or greater than a threshold (for example, five seconds), sequence SQ1 is executed. In sequence SQ1, the packet analysis unit 57 sends the communication packet to the non-realtime communication control unit 62. The non-realtime communication control unit 62 identifies a transfer packet group ID using the non-realtime accumulation policy 67 and accumulates the communication packets in the packet storage 68 in association with the accumulation packet ID and the transfer packet group ID.

When the communication packet is for non-realtime communication and has a tight delay tolerance time that is less than a threshold (for example, five seconds), sequence SQ2 is executed. In sequence SQ2, the packet analysis unit 57 sends the communication packet to the non-realtime communication control unit 62. The non-realtime communication control unit 62 determines a transfer destination route of the communication packet by referring to the non-realtime communication route table 65, and instructs the non-realtime communication packet transmission unit 59 to transfer the communication packet. The non-realtime communication packet transmission unit 59 transmits the communication packet to the next transfer device.

When the communication packet is for realtime communication, sequence SQ3 is executed. In sequence SQ3, the packet analysis unit 57 sends the communication packet to the realtime communication control unit 61. The realtime communication control unit 61 determines a transfer destination route of the communication packet by referring to the realtime communication route table 64, and instructs the realtime communication packet transmission unit 58 to transfer the communication packet. The realtime communication packet transmission unit 58 transmits the communication packet to the next transfer device.

<Sending Process Sequence of Transfer Device>

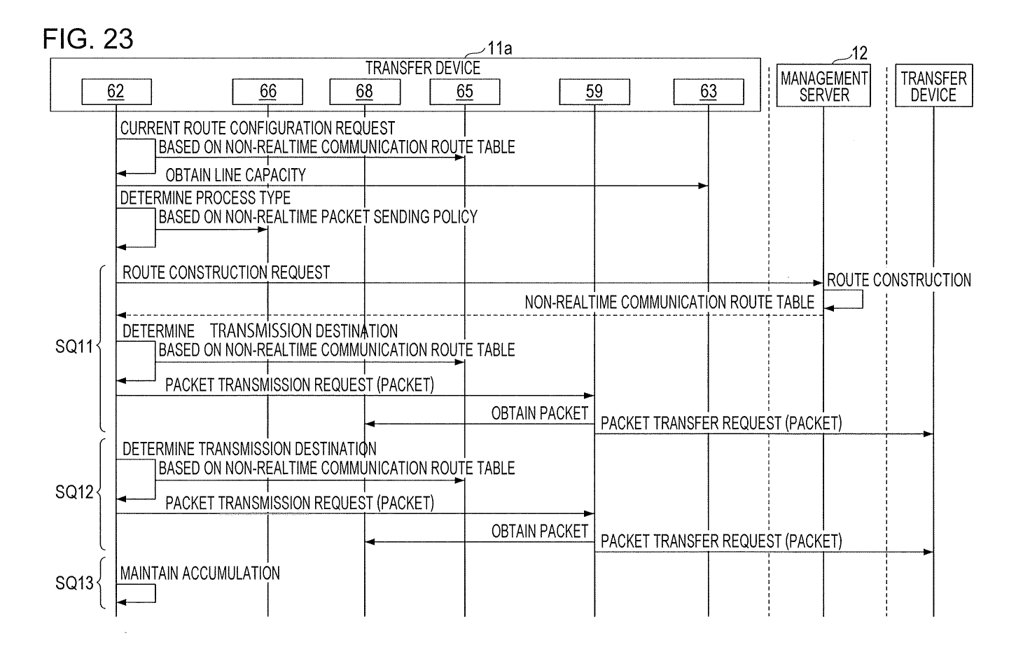

FIG. 23 is a diagram illustrating an example of an operational sequence for processing a communication packet in a transfer device, according to an embodiment. FIG. 23 illustrates a transmission process sequence of a communication packet that is extracted from a packet storage 68 in the transfer device 11a. In FIG. 23, the non-realtime communication control unit 62 determines a transfer destination route of a communication packet that is accumulated in the packet storage 68 and to be transferred, by referring to the non-realtime communication route table 65. Next, the non-realtime communication control unit 62 obtains available capacity of a line for non-realtime communication from the line monitoring unit 63, and obtains an instruction for the process to be executed in the non-realtime communication control unit 62 by referring to the non-realtime packet transmission policy 66.

Here, when a transfer packet group ID of a transfer target is stored in the packet storage 68 and also there is no transfer destination route in the non-realtime communication route table 65, sequence SQ11 is executed. In sequence SQ11, the non-realtime communication control unit 62 requests the management server 12 to construct the transfer destination route that has not been found in the non-realtime communication route table 65. Then, the management server 12 executes route construction process and sends back the updated non-realtime communication route table to the non-realtime communication control unit 62, and the updated non-realtime communication route table is registered in the non-realtime communication route table 65. Thereafter, the non-realtime communication control unit 62 determines a transfer destination route of the communication packet that is to be transmitted from the packet storage 68, by referring to the non-realtime communication route table 65. Then, the non-realtime communication control unit 62 instructs the non-realtime communication packet transmission unit 59 to transfer the communication packet. The non-realtime communication packet transmission unit 59 acquires the communication packet that is to be transmitted from the packet storage 68 and transmits the acquired communication packet to the next transfer device.

When the packet group ID of the transfer target is stored in the packet storage 68 and the transfer destination route exists in the non-realtime communication route table 65, or when the packet group ID of the transfer target is not stored in the packet storage 68 and the transfer destination route exists in the non-realtime communication route table 65, sequence SQ12 is executed. In sequence SQ12, the non-realtime communication control unit 62 determines the transfer destination route of the communication packet that is to be transmitted from the packet storage 68, by referring to the non-realtime communication route table 65. Then, the non-realtime communication control unit 62 instructs the non-realtime communication packet transmission unit 59 to transfer the communication packet. The non-realtime communication packet transmission unit 59 acquires the communication packet to be transmitted from the packet storage 68, and transmits the communication packet to the next transfer device.

When the packet group ID of the transfer target is not stored in the packet storage 68 and there is no transfer destination route in the non-realtime communication route table 65, sequence SQ13 is executed. In sequence SQ13, accumulation of communication packets in the packet storage 68 is maintained.

In the embodiment, only communication packets relating to the non-realtime communication having a wide range of the delay tolerance time are accumulated, and transmission of a communication packet is scheduled based on the amount of data flow and the delay tolerance time of the communication packet so as to maintain a most efficient power saving route.

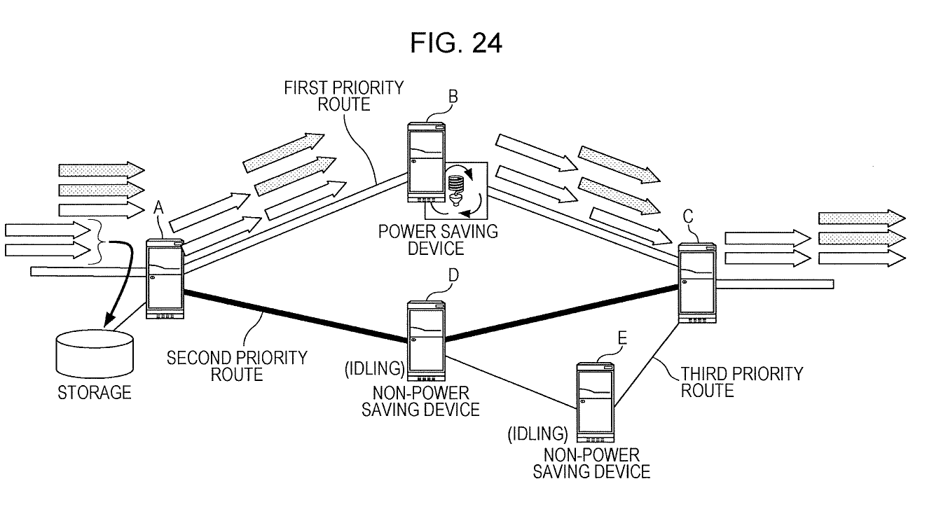

FIG. 24 is a schematic diagram illustrating an example of traffic transfer at an off-peak time, according to an embodiment. In the case of the off-peak time, that is, in the case where the amount of traffic flowing into a transfer device is small, as illustrated in FIG. 24, all traffic of non-realtime communication depicted with white arrows and realtime communication depicted with arrows of halftone dot mesh pattern is transferred using the first priority route (a route passing through the transfer devices A, B, and C).

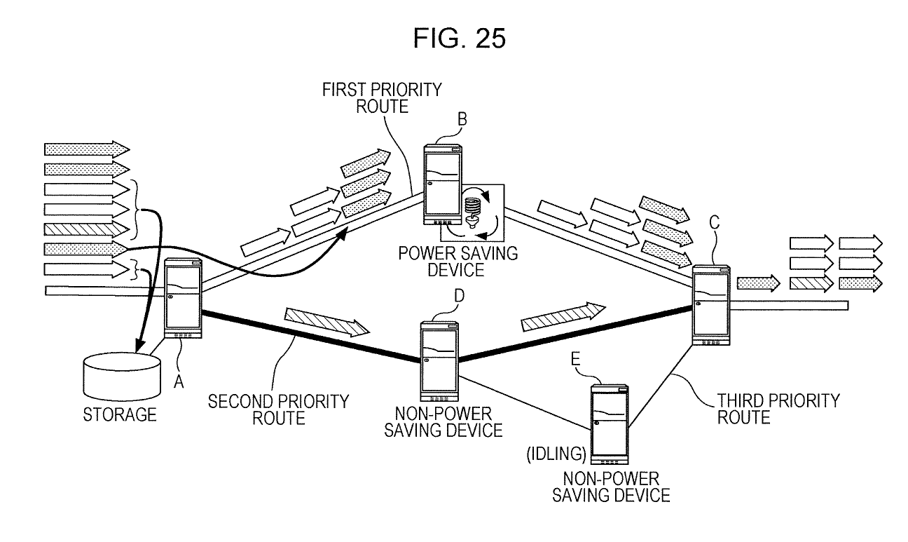

FIG. 25 is a schematic diagram illustrating an example of traffic transfer at a peak time, according to an embodiment. In the case of the peak time, that is, in the case where the amount of traffic flowing into a transfer device is large, as illustrated in FIG. 25, the traffic of non-realtime communication depicted with white arrows is accumulated in the packet storage of the transfer device A and the transmission time thereof is scheduled within a range of the delay tolerance time designated by the communication packet, thereby suppressing activation of the third priority route (a route passing through the transfer devices A, D, E, and C). The traffic of non-realtime communication depicted with hatched arrows represents traffic having a delay tolerance time within a threshold (for example, five seconds) and being transferred through the second priority route (a route passing through the transfer devices A, D, and C), thereby suppressing activation of the third priority route.

Further, when the amount of traffic flowing into a transfer device is small and the traffic has a sufficient delay tolerance time, it is also possible to cause all the routes including the first priority route to enter an idling state by stopping transmission of the traffic for a certain period of time. In this way, a time period during which traffic is transmittable using only the first priority route may be extended and the first priority route may be idled intermittently, thereby contributing to improvement in power saving.

Assume that the total number of the transfer devices operated on the entire network is N, the number of the transfer devices that are running in a non-idling state when using a power saving network control technique in the past is M, and the number of the transfer devices that are running in a non-idling state when using the embodiment is M′. Further assume that a ratio of basic power consumption in an idling state to maximum power consumption for each transfer device is W1, and a ratio of power consumption in a running state, that is, in a non-idling state to the maximum power consumption for each transfer device is W2.

In this case, a reduction rate R, defined as a ratio of the power consumption to be reduced using the embodiment, to the power consumption to be reduced using the power saving network control technique in the past, is represented in the following expression.

R=1−[(N−M′)×W1+M′×W2]/[(N−M)×W1+M×W2]

For example, assuming that W1=20% (0.2) and W2=70% (0.7), since N=5, M=4, M′=3 at the off-peak time as indicated in FIG. 1, the reduction rate R becomes approximately 17%. Meanwhile, since N=5, M=5, M′=4 at the peak time, the reduction rate R becomes approximately 14%. Therefore, since more transfer devices are used for actual operation, even larger power reduction may be expected according to the embodiments. Recently, since it is desired to reduce power consumption and CO₂, areas of business application may be expanded by implementing the embodiments.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A method for controlling data transmission based on power consumption of nodes in a communication network, the method comprising:
providing each of the nodes with communication route information that stores information on a plurality of transmission routes communicably coupling a transmission source and a transmission destination via the communication network;
receiving, by the each node, transmission data;
transmitting, by the each node, the transmission data using a first transmission route having power consumption that is least among the plurality of transmission routes when the transmission data is realtime data and the first transmission route has available bandwidth capacity enough for transmitting the realtime data, the power consumption of a transmission route being defined as a total sum of power consumption of nodes along the transmission route, the realtime data being data that is required to be transmitted on a realtime basis;
setting, by the each node, a second transmission route bypassing the first transmission route when the transmission data is the realtime data and the first transmission route does not have available bandwidth capacity enough for transmitting the realtime data; and
performing, by the each node, a predetermined process without setting the second transmission route when the transmission data is non-realtime data and the first transmission route does not have available bandwidth capacity enough for transmitting non-realtime data, the non-realtime data being data that is not required to be transmitted on a realtime basis.

2. The method of claim 1, wherein
as the predetermined process, the each node stores the transmission data in a memory provided for the each node.

3. The method of claim 2, wherein
the each node transmits the transmission data that has been stored in the memory as the non-realtime data, using the first transmission route, when the first transmission route has available bandwidth capacity enough for transmitting the non-realtime data; and
the each node sets the second transmission route and transmits the transmission data that has been stored in the memory as the non-realtime data, using the second transmission route, when the first transmission route does not have available bandwidth capacity enough for transmitting the non-realtime data and a delay time for which the transmission data is allowed to be delayed is expected to expire, the delay time being included in the transmission data.

4. A system for controlling data transmission based on power consumption of nodes in a communication network, the system comprising:
a terminal-side device communicably coupled to the communication network; and
a plurality of transfer devices each configured to transfer data based on communication route information that stores information on a plurality of transmission routes communicably coupling a transmission source and a transmission destination via the communication network, wherein
the terminal-side device is configured to add identification information and time information to transmission data, the identification information identifying a type of the transmission data, the time information indicating a delay time for which the transmission data is allowed to be delayed;
each of the plurality of transfer devices is configured:
to receive the transmission data transmitted from the terminal-side device,
to determine, based on the identification information included in the received transmission data, whether the received transmission data is realtime data that is required to be transmitted on a realtime basis or non-realtime data that is not required to be transmitted on a realtime basis,
to transmit the transmission data using a first transmission route having power consumption that is least among the plurality of transmission routes when the transmission data is the realtime data and the first transmission route has available bandwidth capacity enough for transmitting the realtime data, the power consumption of a transmission route being defined as a total sum of power consumption of transfer devices along the transmission route,
to set a second transmission route bypassing the first transmission route when the transmission data is the realtime data and the first transmission route does not have available bandwidth capacity enough for transmitting the realtime data; and
to store the transmission data into a memory provided for the each transfer device when the transmission data is the non-realtime data and the first transmission route does not have available bandwidth capacity enough for transmitting the non-realtime data.

5. The system of claim 4, wherein
the each transfer device transmits the non-realtime data using the first transmission route when the transmission data is the non-realtime data and the first transmission route has available bandwidth capacity enough for transmitting the non-realtime data; and
the each transfer device sets the second transmission route and transmits the transmission data using the second transmission route when the transmission data is the non-realtime data, the first transmission route does not have available bandwidth capacity enough for transmitting the non-realtime data, and the delay time indicated by the time information is expected to expire.

6. The system of claim 4, wherein
the each transfer device transmits the transmission data that has been stored in the memory as the non-realtime data, using the first transmission route, when the first transmission route has available bandwidth capacity enough for transmitting the non-realtime data; and
the each transfer device sets the second transmission route and transmits the transmission data that has been stored in the memory as the non-realtime data, using the second transmission route, when the first transmission route doest not have available bandwidth capacity enough for transmitting the non-realtime data and the delay time indicated by the time information is expected to expire.

7. An apparatus for controlling data transmission based on power consumption of nodes in a communication network, the apparatus serving as any one of the nodes, apparatus comprising:
a memory configured to store communication route information that stores information on a plurality of transmission routes communicably coupling a transmission source and a transmission destination via the communication network; and
a processor configured:
to receive transmission data,
to determine, based on identification information included in the transmission data, whether the transmission data is realtime data that is required to be transmitted on a realtime basis or non-realtime data that is not required to be transmitted on a realtime basis,
to transmit the transmission data using a first transmission route having power consumption that is least among the plurality of transmission routes when the transmission data is the realtime data and the first transmission route has available bandwidth capacity enough for transmitting the realtime data, the power consumption of a transmission route being defined as a total sum of power consumption of the nodes along the transmission route,
to set a second transmission route bypassing the first transmission route when the transmission data is the realtime data and the first transmission route does not have available bandwidth capacity enough for transmitting the realtime data, and
to store the transmission data in the memory when the transmission data is the non-realtime data and the first transmission route does not have available bandwidth capacity enough for transmitting the non-realtime data.

8. The apparatus of claim 7, wherein
the processor is configured:
to transmit the transmission data using the first transmission route when the transmission data is the non-realtime data and the first transmission route has available bandwidth capacity enough for transmitting the non-realtime data; and
to set the second transmission route bypassing the first transmission route and transmit the transmission data using the second transmission route when the transmission data is the non-realtime data, the first transmission route does not have available bandwidth capacity enough for transmitting the non-realtime data, and a delay time for which the transmission data is allowed to be delayed is expected to expire, the delay time being included in the transmission data.

9. The apparatus of claim 8, wherein
the processor transmits the transmission data that has been stored in the memory as the non-realtime data, using the first transmission route, when the first transmission route has available bandwidth capacity enough for transmitting the non-realtime data; and
the processor sets the second transmission route and transmits the transmission data that has been stored in the memory as the non-realtime data, using the second transmission route, when the first transmission route does not have available bandwidth capacity enough for transmitting the non-realtime data and a delay time for which the transmission data is allowed to be delayed is expected to expire, the delay time being included in the transmission data.
